(19) United States
(12) Patent Application Publication
(10) Pub. No.: US 2017/0043989 A1
(43) Pub. Date: Feb. 16, 2017

(54) WINGED CORKSCREW WITH ONE OR MORE SECONDARY UTENSILS

(71) Applicants: Kenneth S. Kwak, Culver City, CA (US); Michelle Ho Kwak, Culver City, CA (US)

(72) Inventors: Kenneth S. Kwak, Culver City, CA (US); Michelle Ho Kwak, Culver City, CA (US)

(21) Appl. No.: 14/824,800

(22) Filed: Aug. 12, 2015

(51) Int. Cl. B67B 7/04; B26B 11/00

(52) U.S. Cl. CPC B67B 7/0441; B26B 11/00; B67B 2007/0458

(57) ABSTRACT

A winged corkscrew with one or more secondary utensils. The winged corkscrew secondary utensils may comprise: a shaft, body, two levers, and two pins. The shaft may comprise: a handle portion, secondary utensils, a rack portion, and a helical portion. The handle portion may comprise an opening and a lip disposed along the inner edge of the opening. The blade may be hingedly disposed between the handle portion and the rack portion, which is positioned adjacent to the helical portion. The body may comprise: a through hole, base, and two shoulders. The two levers may pivotally engage with the two shoulders via the two pins. The shaft may engage and extend through the through hole of the body, such that the helical portion of the shaft is disposed within the body. The base may be substantially cylindrical and may be adapted to engage with a neck portion of a bottle.

### FIELD OF USE

The present disclosure relates generally to corkscrews, and more particularly, to winged corkscrews with one or more built-in utensils.

### BACKGROUND

Wine bottles are frequently sealed with corks, which are then covered with a shrink wrapped foil. Both the foil and the cork must be removed prior to wine consumption. A tool, usually a corkscrew, is used in order to remove the cork from the wine bottle. The user twists and inserts the “worm” or metallic helix of the corkscrew into the cork and then draws out the cork from the wine bottle.

Various types of corkscrews exist, most of which comprise at least a metallic helix for drawing the cork from the wine bottle. One of the most popular corkscrews in households, however, is the winged corkscrew. The winged corkscrew (also known as the “butterfly” corkscrew) comprises two levers and a rack and pinion. Each of the two levers are positioned on either side of the worm and engage the worm via the rack and pinion. As the worm is twisted into the cork, the levers are raised. The user may then push down onto the levers to draw the cork from the bottle.

Another type of corkscrew is the traditional twist and pull corkscrew. The twist and pull corkscrew includes a handle and worm attached perpendicularly to the handle. The user engages the worm into the cork, twists, and pulls the cork from the wine bottle. Despite the simplicity of this design, this corkscrew, unlike the winged corkscrew, is typically hard to use and requires a lot of strength from the user.

A third type of corkscrew is the sommelier knife (also known as the “waiter's friend” or “wine key”). The sommelier knife is a corkscrew with a folding body structurally similar to a pocket knife. The worm is hingedly attached to the body and is protracted outwards when in use. After the user inserts the worm into cork, the user extends an arm of the corkscrew to brace against the lip of the bottle for leverage. The user then removes the cork from the bottle by repeatedly leveraging the corkscrew away from the arm. Although the sommelier knife is generally portable, this corkscrew requires more skill from the user than the winged corkscrew.

A fourth type of corkscrew is the “rabbit ears” corkscrew or lever corkscrew. The lever corkscrew includes a lever and a pair of handles, which are adapted to grip the neck of the bottle. After the handles grip the bottle, the user presses the lever down to twist the screw into the cork, and then later lifts the lever to extract the cork. Unlike the winged corkscrew, however, this corkscrew is much bulkier, typically much more expensive, and does not last very long before breaking.

Similarly, a fifth type of corkscrew is the table top wine opener that also includes a lever and a pair of handles for securing the bottle and extract the cork. However, unlike the lever corkscrew, table top wine openers are generally affixed to or fastened onto the bases or counters and are generally not portable. Thus, these corkscrews are much bulkier and are typically expensive than the winged corkscrew.

A sixth type of wine opener is the electric wine opener. This electric wine bottle opener generally includes a cylindrical round body, electric motor, and metallic helix coupled to the motor. The body engages with the neck of the bottle, and the electric motor is actuated to engage and remove the cork via twisting. The electric wine opener is very simple to use, but is generally limited due to its design. Specifically, unlike the winged corkscrew, the electric wine opener requires batteries and is very mundane when used by the user.

Finally, a seventh type of wine opener is the “Ah-So” wine opener, which includes a twin-prong cork puller that engages and extracts a cork. In order for the cork to be removed, the user pushes the prongs between the cork and the neck of the bottle and twists the cork out of the bottle. The design of this corkscrew is very simple. However, a major drawback of this corkscrew is that this corkscrew is much more difficult to use and requires skill and strength to pull the cork, as opposed to the winged corkscrew.

Although some of the aforementioned corkscrews offer a secondary utensil to help remove the foil wrappings attached to the upper portion of the wine bottle, such as the wine key opener, many of the corkscrews, including the winged corkscrew do not offer such a secondary utensil. Most wine bottles are covered and sealed with the foil wrapping, which must be removed, in order for the corkscrew to access the cork. As a result, consumers using a corkscrew device without a secondary utensil must retrieve and utilize a second tool to cut and remove the foil wrapper of the wine bottle. The necessity of using this second tool is often very inconvenient, as many users typically resort to searching and using a standard household knife to cut the foil wrapper off the wine bottle, which can be very hazardous.

Additionally, consumers may need to use additional tools to remove the cork. For example, in the event that a portion of the cork is stuck in the neck of the bottle, tools such as pointed instrument (e.g., prick, double prick) may be needed to remove these cork portions from the wine bottle. Many users do not anticipate the need of these additional tools, and the lack of such tools are generally an inconvenience to these users.

Therefore, based on the foregoing, there is a need for a multi-tool winged corkscrew that can be used as a single device to safely remove a foil wrapper and cork from a wine bottle without the use of any other devices. Preferably, this corkscrew is a winged corkscrew that may also be used for other tasks such as removing broken pieces of cork stuck in the neck of the bottle and removing bows and strings when the bottle is wrapped, as in a gift.

### SUMMARY OF EMBODIMENTS

To minimize the limitations in the prior art, and to minimize other limitations that will become apparent upon reading and understanding the present disclosure, the present specification discloses a new and improved winged corkscrew with one or more secondary utensils. Preferably, the new and improved winged corkscrew disclosed herein will provide the additional step(s) of safely remove a foil wrapper and/or cork from a bottle without the use of any other devices. Additional steps may also be used for other tasks such as removing broken pieces of cork stuck in the neck of the bottle and cutting bows and strings when the bottle is wrapped as a gift using a scissor of the winged corkscrew.

One embodiment may be a winged corkscrew with one or more secondary utensils, comprising: a shaft; a body; and two levers; wherein each of the two levers comprise a pin, such that there are two pins; wherein the shaft comprises: a handle portion, one or more secondary utensils, a rack portion, and a helical portion; wherein the handle portion is positioned at an upper end of the shaft; wherein the one or more secondary utensils are hingedly disposed between the handle portion and the rack portion; wherein the rack portion is disposed between the one or more secondary utensils and the helical portion; wherein the helical portion is positioned at a bottom end of the shaft and is configured to engage with and remove a cork from a bottle; wherein the body comprises a through hole, two shoulders, and a base; wherein the through hole is positioned approximately at the upper end of the body, between the two shoulders, and above the base; wherein the shaft engages with and extends through the through hole of the body; wherein a proximal ends of the two levers comprises a plurality of gear teeth; wherein the proximal ends of the one or more levers pivotally rotates with the one or more shoulders of the body via the two pins, such that the plurality of gear teeth of the two levers moveably rotate adjacent to the through hole; wherein the rack portion of the shaft engages with the plurality of gear teeth of the two levers; and wherein the base of the body is substantially cylindrical and is adapted to engage with a neck portion of a bottle. The one or more secondary utensils may be aligned in a substantially horizontal manner, such that a length of the one or more secondary utensils transverses longitudinally along a bottom portion of the handle portion, such that the one or more secondary utensils are substantially perpendicular to the shaft. The handle portion of the shaft may comprise at least one opening and at least one lip; wherein the at least one lip may be disposed along an inner edge of the at least one opening; and wherein the at least one lip may be adapted to engage with a sealing cap of a bottle, such that the handle portion functions as a bottle cap opener. A shape of the handle portion of the shaft may be selected from the group of shapes consisting of: a rectangular shape, a trapezoidal shape, and a circular shape. The one or more secondary utensils may be aligned along a lower portion the handle portion, such that the winged corkscrew may be configured to align with a top portion of a bottle. The one or more secondary utensils may be aligned along a lower portion the handle portion to provide compactness of the one or more secondary utensils. The one or more secondary utensils may include a blade. The one or more secondary utensils may include a double-point prick. The one or more secondary utensils may include a serrated blade. The one or more secondary utensils may include a screwdriver tip. The one or more secondary utensils may be selected from the group of secondary utensils consisting of: a cap lifter, a single-point prick, and a scissor tip.

Another embodiment may be a winged corkscrew with one or more secondary utensils, comprising: a shaft; a body; and two levers; wherein each of the two levers comprise a pin, such that there are two pins; wherein the shaft comprises: a handle portion, at least one secondary utensil, a rack portion, and a helical portion; wherein the handle portion is positioned at an upper end of the shaft and comprises at least one opening; wherein the at least one secondary utensil is hingedly disposed between the handle portion and the rack portion; wherein the rack portion is disposed between the at least one secondary utensil and the helical portion; wherein the helical portion is positioned at a bottom end of the shaft and is configured to engage with and remove a cork from a bottle; wherein a proximal ends of the two levers comprise a plurality of gear teeth; wherein the body comprises: a through hole, two shoulders, and a base; wherein the through hole is positioned approximately at an upper end of the body, between the two shoulders, and above the base; wherein the proximal ends of the two levers pivotally rotates with the two shoulders of the body via the two pins, such that the plurality of gear teeth of the two levers moveably rotate adjacent to the through hole; wherein the shaft engages and extends through the through hole of the body, such that the helical portion of the shaft is disposed within the body and the rack portion of the shaft engages with the plurality of gear teeth of two levers; and wherein the base of the body is substantially cylindrical and is adapted to engage with a neck portion of a bottle. The at least one secondary utensil may be aligned in a substantially horizontal manner, such that a length of the at least one secondary utensil may transverse longitudinally along a bottom portion of the handle portion, such that the one or more secondary utensils may be substantially perpendicular to the shaft. The handle portion of the shaft may comprise at least one opening and at least one lip; wherein the at least one lip may be disposed along an inner edge of the at least one opening; and wherein the at least one lip may be adapted to engage with a sealing cap of a bottle, such that the handle portion may function as a bottle cap opener. A shape of the handle portion of the shaft may be selected from the group of shapes consisting of: a rectangular shape, a trapezoidal shape, and a circular shape. The one or more secondary utensils may be aligned along a lower portion the handle portion, such that the winged corkscrew may be configured to align with a top portion of a bottle. The one or more secondary utensils may be aligned along a lower portion the handle portion to provide compactness of the one or more secondary utensils. The at least one secondary utensil may be a blade. The at least one secondary utensil may be selected from the group of secondary utensils consisting of: a blade, a serrated blade, a cap lifter, a single-point prick, a double-point prick, a scissor tip, and a screwdriver tip.

Another embodiment may be a winged corkscrew with one or more secondary utensils, consisting essentially of: a shaft; a body; a first lever, comprising a first pin; and a second lever, comprising a second pin; wherein the shaft consists essentially of: a handle portion, two secondary utensils, a rack portion, and a helical portion; wherein the handle portion is positioned at an upper end of the shaft and comprises at least one opening and at least one lip; wherein the at least one lip is disposed along an inner edge of the at least one opening and is adapted to engage with a sealing cap of a bottle, such that the shaft functions as a bottle cap opener; wherein the two secondary utensils are hingedly disposed between the handle portion and the rack portion and is aligned in a substantial horizontal manner, such that a length of the two secondary utensils transverse longitudinally along a bottom portion of the handle portion; wherein the rack portion is disposed between the two secondary utensils and the helical portion; wherein the helical portion is positioned at a bottom end of the shaft and is configured to engage with a cork; wherein a proximal end of the first lever comprises a plurality of gear teeth; wherein a proximal end of the second lever comprises a plurality of gear teeth; wherein the body comprises: a through hole, a first shoulder, a second shoulder, and a base; wherein the through hole is positioned at an upper end of the body, adjacent to and between the first shoulder and the second shoulder, and above the base; wherein the proximal end of the first lever pivotally engages with the first shoulder of the main body via the first pin, such that the plurality of gear teeth of the first lever moveably rotates adjacent to the through hole; wherein the proximal end of the second lever pivotally engages with the second shoulder of the main body via the second pin, such that the plurality of gear teeth of the second lever also moveably rotates adjacent to the through hole; wherein the shaft engages and extends through the through hole of the body, such that the helical portion of the shaft is disposed within the body and the rack portion of the shaft engages with the plurality of gear teeth of the first lever and the plurality of gear teeth of the second lever; and wherein the base of the body is substantially cylindrical and is adapted to engage with a neck portion of the bottle.

Another embodiment may be a method of removing a cork from the bottle. In this embodiment, the method may comprise the steps of: providing a winged corkscrew with one or more secondary utensils; protracting the one or more secondary utensils from a shaft of the winged corkscrew; positioning the protracted one or more secondary utensils against a foil wrapper of a sealed bottle; cutting the foil wrapper with the one or more secondary utensils; removing the foil wrapper from the bottle; engaging a helical portion of the shaft of the winged corkscrew with a cork of the bottle; twisting the shaft until the levers of the winged corkscrew is raised; and drawing the cork from the bottle by applying pressure towards the raised levers.

In one embodiment, the winged corkscrew with one or more secondary utensils may comprise a single cutting utensil or blade. In another embodiment, the winged corkscrew with one or more secondary utensils may comprise multiple cutting utensils. These multiple cutting utensils or blades may be connected to the handle of the combination tool by a single hinge.

In various embodiments, each secondary utensil attached to the multi-tool corkscrew may have a notch, which assists in unhinging the utensil.

It is an object to provide a new and improved winged corkscrew with a secondary utensil that is horizontally disposed to allow for the safe removal of a foil wrapper and/or cork from a wine bottle without the use of any other devices. Unlike other existing corkscrews, the secondary utensil is preferably disposed at the lower horizontal position of within the handle to help align the utensil when cutting the foil. In other words, the position of the secondary utensils help the user by positioning the winged corkscrew in a convenient manner when cutting and removing the foil wrapper.

It is an object to provide a new and improved winged corkscrew with a secondary utensil that may be stored in a portion of the wine bottle opener when not in use. Unlike conventional corkscrews, the new and improved winged corkscrew disclosed herein provides additional utensils (e.g., screwdrivers, wire strippers, scissors, reamer, screwdrivers, pins, chisels, metal files, peelers) not found in conventional corkscrews.

It is an object to provide a new and improved winged corkscrew that may provide additional functions and features when opening a bottle, including, but not limited to, tightening screws and opening boxes.

It is an object to provide a new and improved winged corkscrew with a secondary utensil located between a handle and a rack to allow for an ergonomic design.

It is an object to provide a new and improved winged corkscrew with a handle comprising a hole suited for opening a bottle top.

It is an object to provide a wine bottle opener or corkscrew that is makes the cork-removing process simpler, easier, and more efficient. In a preferred embodiment, the corkscrew is a winged-type corkscrew comprising at least one cutting utensil.

It is an object to provide various types of utensils connected to a wine bottle opener such as cutting utensils to improve the cork removing process.

It is an object to overcome the deficiencies of the prior art.

These, as well as other components, steps, features, objects, benefits, and advantages, will now become clear from a review of the following detailed description of illustrative embodiments, of the accompanying drawings, and of the claims.

### BRIEF DESCRIPTION OF THE ILLUSTRATIVE EMBODIMENTS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

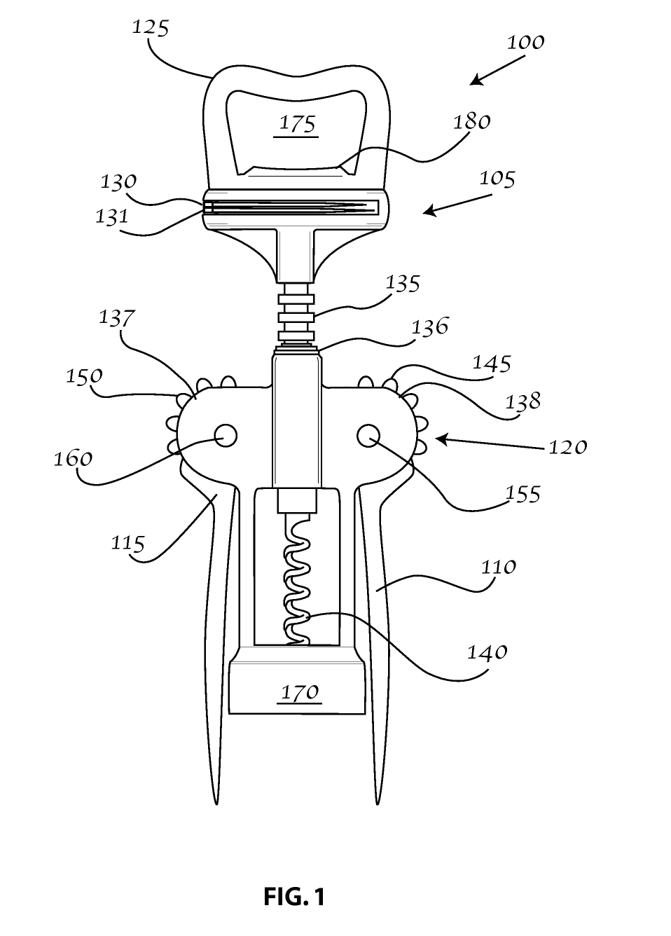

FIG. 1 is an illustration of a front elevational view of one embodiment of the winged corkscrew with one or more secondary utensils.

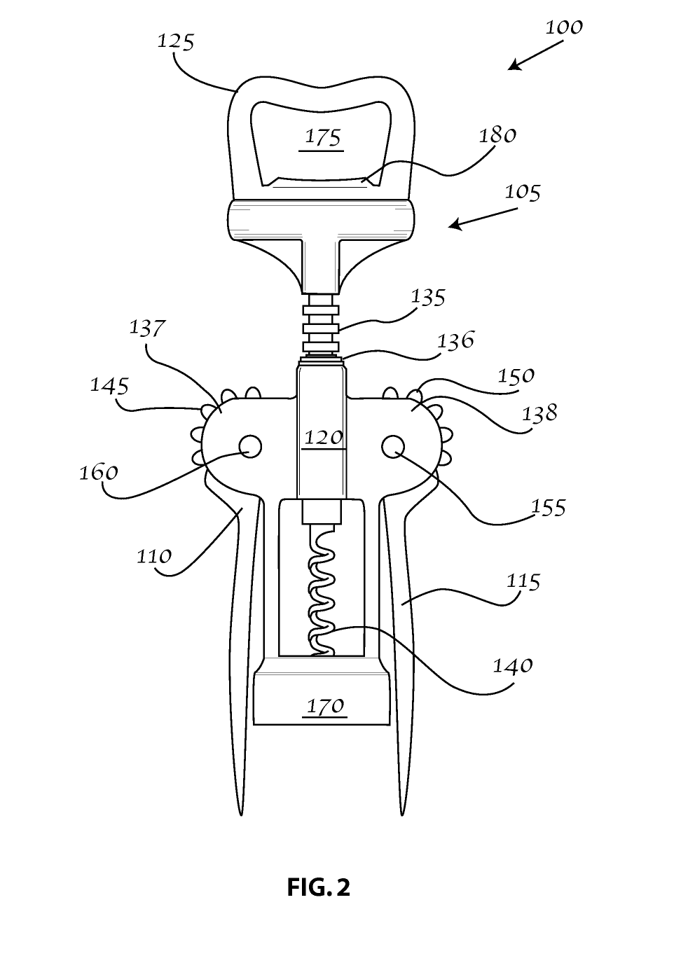

FIG. 2 is an illustration of a rear elevational view of one embodiment of the winged corkscrew with one or more secondary utensils.

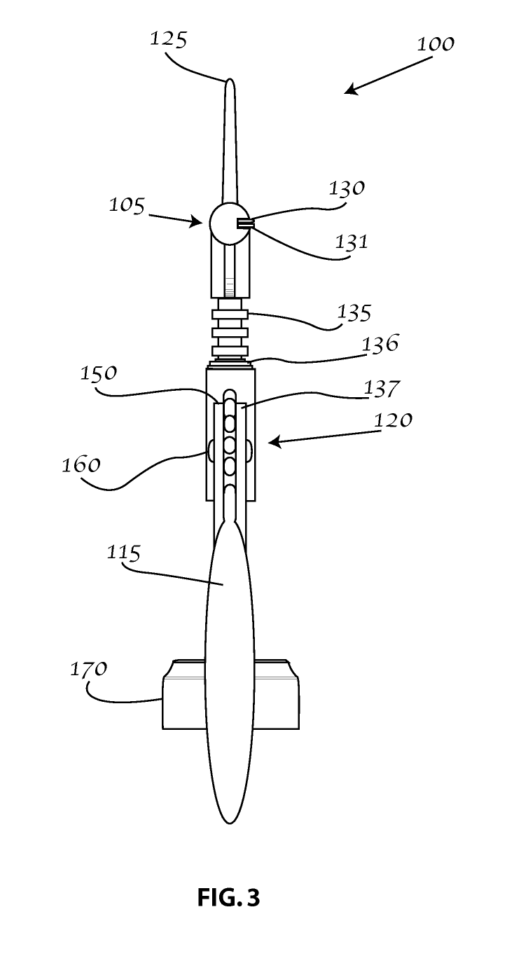

FIG. 3 is an illustration of a right side elevational view of one embodiment of the winged corkscrew with one or more secondary utensils.

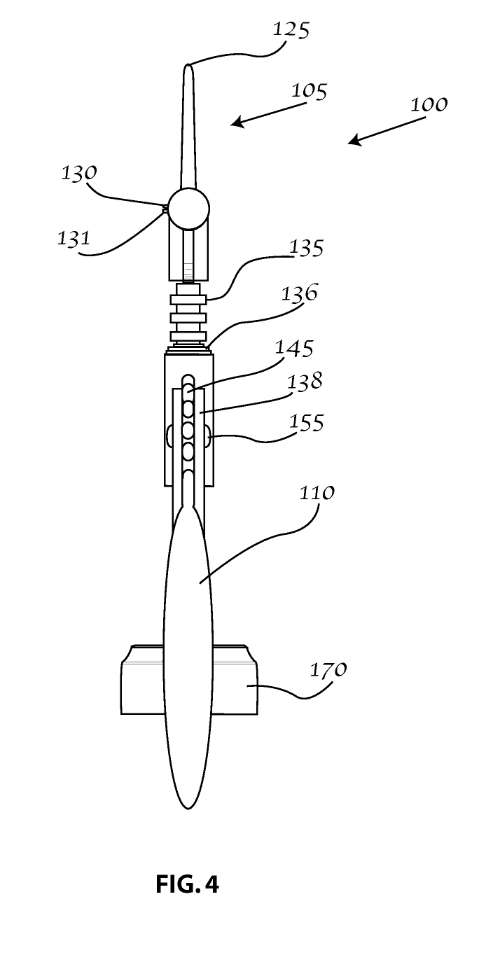

FIG. 4 is an illustration of a left side elevational view of one embodiment of the winged corkscrew with one or more secondary utensils.

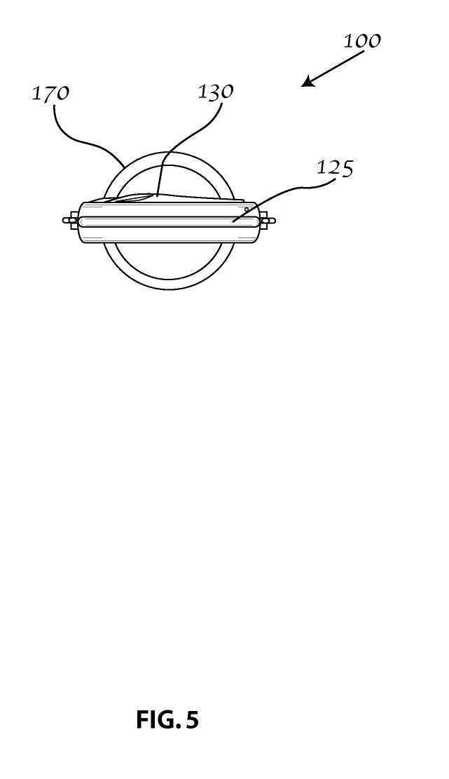

FIG. 5 is an illustration of a top plan view of one embodiment of the winged corkscrew with one or more secondary utensils.

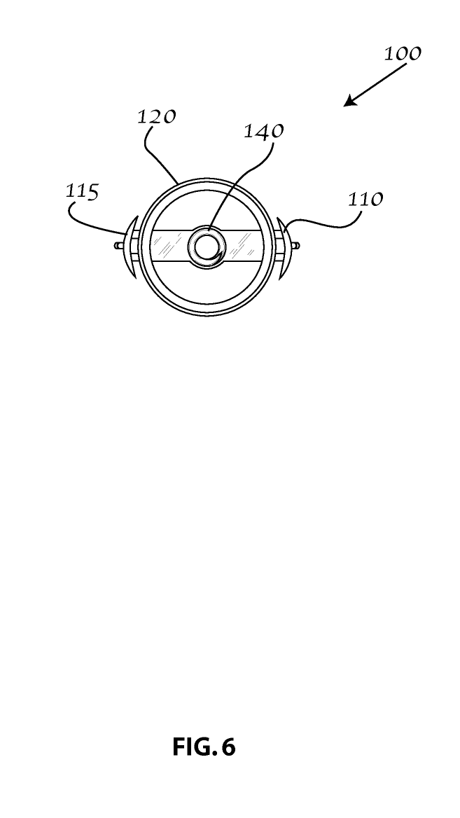

FIG. 6 is an illustration of a bottom plan view of one embodiment of the winged corkscrew with one or more secondary utensils.

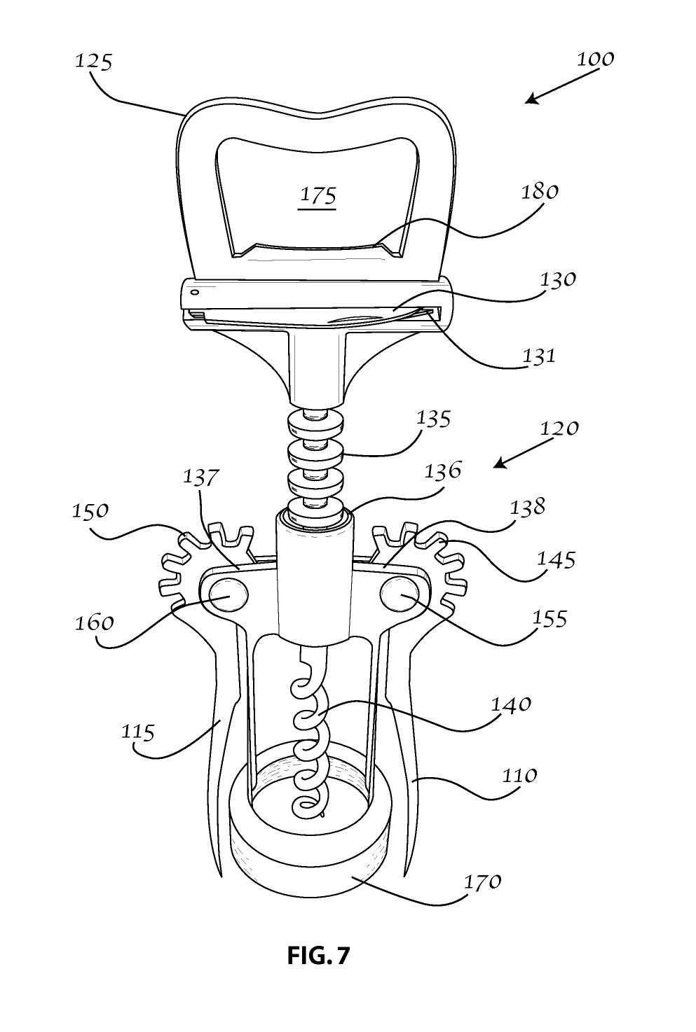

FIG. 7 is an illustration of a perspective view of one embodiment of the winged corkscrew with one or more secondary utensils.

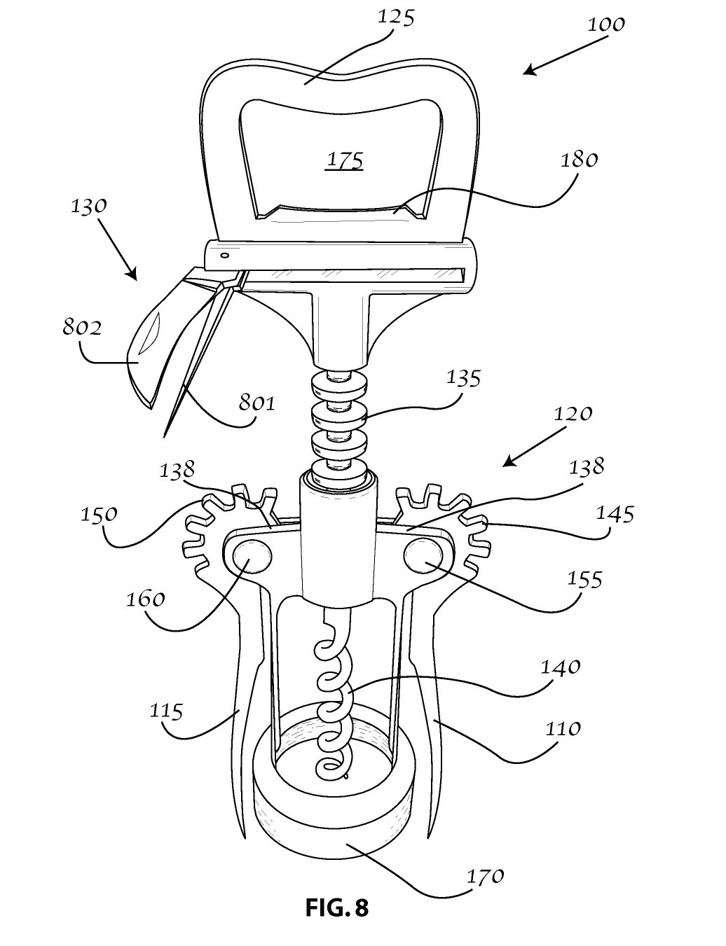

FIG. 8 is an illustration of a perspective view of one embodiment of the winged corkscrew with one or more secondary utensils and shows two secondary utensils hingedly protracted.

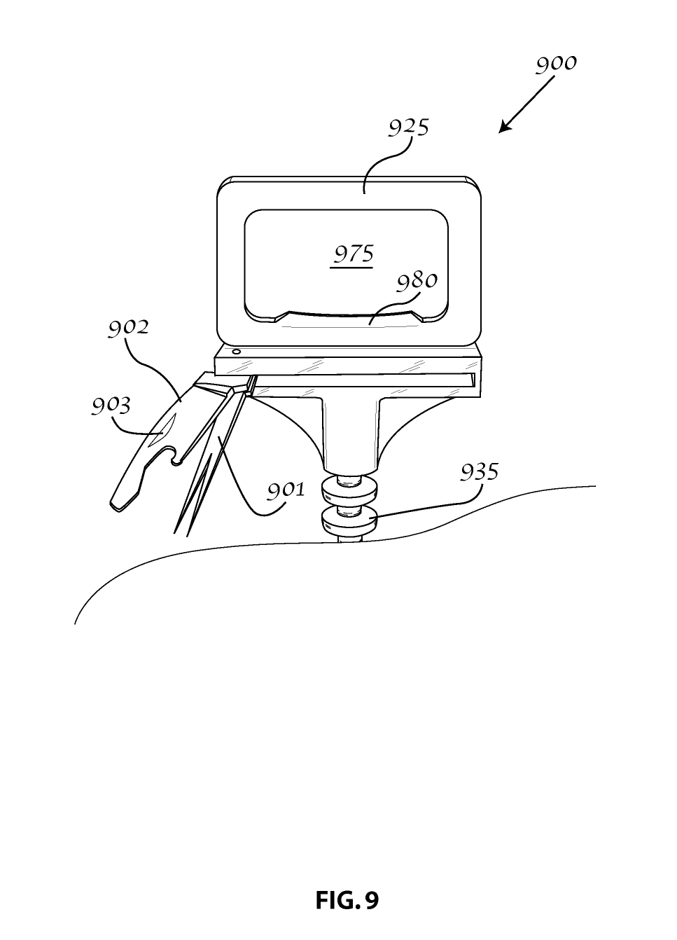

FIG. 9 is an illustration of another embodiment of the handle portion of the corkscrew with one or more secondary utensils and shows the secondary utensils as a can opener with a double-point prick.

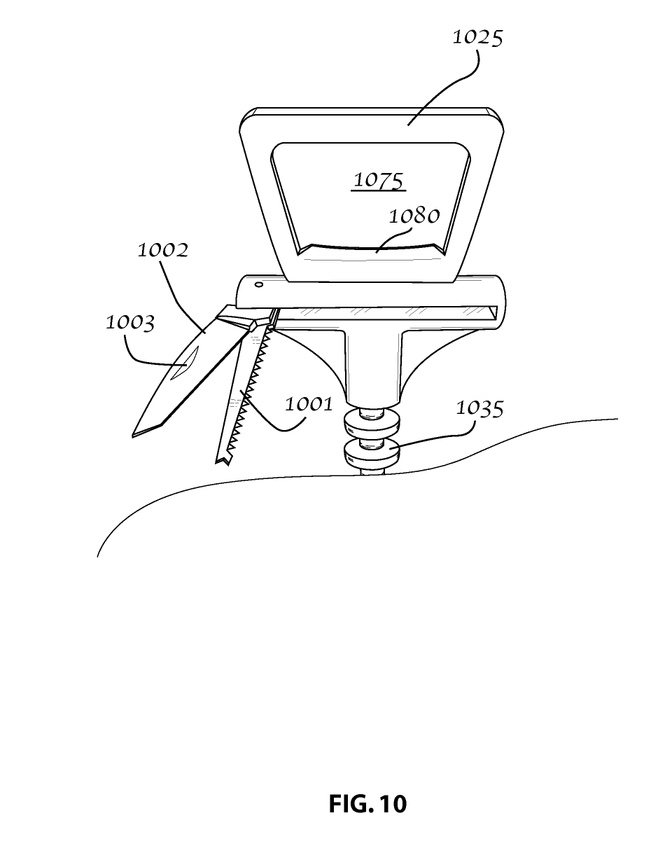

FIG. 10 is an illustration of another embodiment of the handle portion of the corkscrew with one or more secondary utensils and shows the secondary utensils as a cutting tool and a serrated blade.

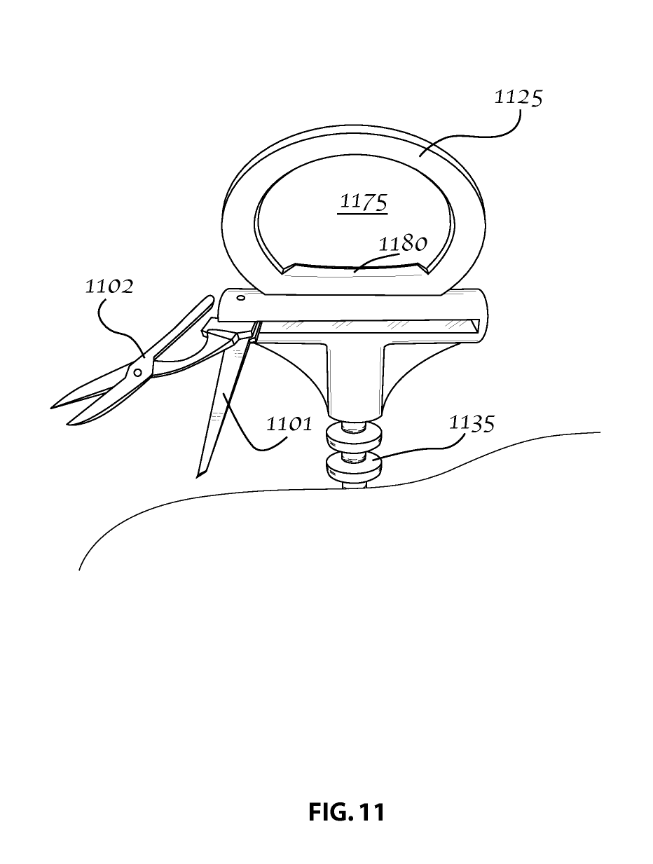

FIG. 11 is an illustration of another embodiment of the handle portion of the corkscrew with one or more secondary utensils and shows the secondary utensils as scissors and a single-point prick.

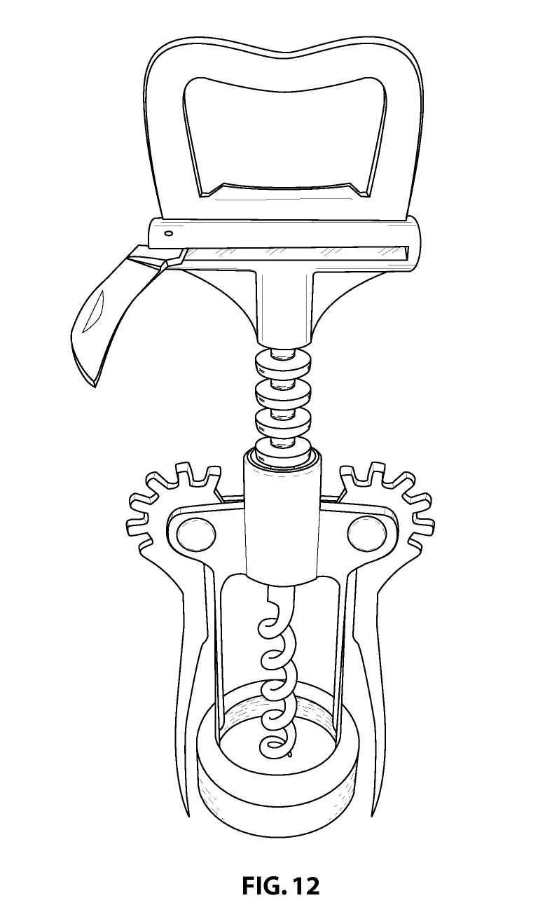

FIG. 12 is an illustration of a perspective view of one embodiment of the winged corkscrew and shows the corkscrew with a single secondary utensil.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

As used herein, the term “rectangular” refers to a shape having a form of a rectangle or four-sided flat shape with straight sides. All the interior angles of a rectangular shape may be right angles and are approximately 90° degrees each.

As used herein, the term “trapezoidal” refers to a shape having a form of a trapezoid or any four-sided shape that has two sides that are substantially in parallel and two sides that are not parallel. The sum of the interior angles of a trapezoidal shape is preferably 360° degrees.

As used herein, the term “circular” refers to a shape having a form of a circle or any shape having a closed plane curve. A circular shape may include, without limitation, circles, ovals, and ellipses.

The term “utensil” refers to any tool, including without limitation, blades (e.g., large blade, small blade, serrated blade, blade without points, electrician blade, picker blade, pruning blade), can openers, bottle openers, screwdrivers, wire strippers, scissors, reamers, screwdrivers (e.g., Phillips, flat heads), pins, chisels, metal files, peelers, and cutters.

FIG. 1 is an illustration of a front elevational view of one embodiment of the winged corkscrew with one or more secondary utensils. As shown in FIG. 1, one embodiment of the winged corkscrew with one or more secondary utensils 100 may comprise: a shaft 105, two levers 110, 115, and body 120. The shaft 105 may comprise: a handle portion 125, secondary utensils 130, 131, rack 135, and helical portion 140. The handle portion 125 of the shaft 105 is preferably configured for the user to hold and control the combination tool 100. The handle portion 125 may comprise an opening 175 and a lip 180 located along the inner edge of the opening 175. The lip 180, handle 125, and opening 175 may be used to latch onto a cap or sealing cap of a bottle and may allow for the shaft 105 to function as a lever to remove the bottle cap. A user, for instance, may move the shaft 105 upwards such that the corkscrew 100 functions as a bottle cap remover for removing a bottle cap from a bottle. In a preferred embodiment, the size of the opening 175 is preferably proportionate to the size of a standard bottle cap, such that the lip 180 in conjunction with the opening 175 and handle portion 125 may be used to engage and remove a bottle cap from a bottle. Additionally, in various embodiments, the shape of the handle portion 125 may comprise, without limitation: rectangular, circular, trapezoidal, square, octagonal, hexagonal, organic, and/or heptagonal.

The secondary utensils 130, 131 may preferably be any tool that may assist the user in removing a cork from a cork stoppered bottle. The secondary utensils 130, 131 may be any tool such as a cutting tool which may be used for shear deformation. The secondary utensils 130, 131 may comprise, without limitation, blades (e.g., large blade, small blade, serrated blade, blade without points, electrician blade, picker blade, pruning blade), can openers, bottle openers, screwdrivers, wire strippers, scissors, reamer, screwdrivers (e.g., Phillips, flat heads), pins, chisels, metal files, peelers, and cutters. In one embodiment, there may be a single secondary utensil while, in various other embodiments, there may also be more than one secondary utensils such as two, three, or four. The secondary utensil may be a blade for slicing or cutting foil wrapper from the bottle. The secondary utensil may also be a scissor for cutting the foil wrapper, plastic wrapping, and/or outside packaging of the bottle (e.g., box packaging, plastic shrink-wrap). The scissors, for example, may be used for cutting the bow and string of the bottle when the bottle is gift-wrapped. Various other secondary utensils may also be used to assist the user in other situations.

In a preferred embodiment, the secondary utensils 130, 131 are positioned below the handle portion 125 and lip 180 and above the rack portion 135 of the shaft 105. Additionally, as shown in the figures, the secondary utensils 130, 131 are preferably disposed in a substantial horizontal manner along the lower portion of the handle portion 125, such that the secondary utensils 130, 131 are substantially perpendicular to the shaft 105. This design and configuration preferably allows the user to position the winged corkscrew 100 in a convenient manner, such that the corkscrew 100 may align in a parallel manner with a wine bottle when removing the foil wrapper. Another benefit of having the secondary utensils 130, 131 aligned along the lower portion of the handle 125 is to provide compactness and an aesthetically pleasing look to the user. This allows the winged corkscrew 100 to hold and secure multiple secondary utensils within the winged corkscrew without significantly increasing the size of the corkscrew.

FIG. 1 also shows that the shaft 105 may comprise a rack portion 135 formed vertically along the middle portion of the shaft 105. The rack portion 135 preferably comprises a plurality of grooves for engaging the gear teeth 145, 150 of the levers 110, 115, thereby providing vertical displacement of the shaft 105 upon actuation of the levers 110, 115.

FIG. 1 also shows that the shaft 105 may comprise a helical portion 140, which is preferably positioned below the rack portion 135. The helical portion 140, which is also called a worm, may extend downwards, along the length of the bottom portion of the shaft 105, and may comprise a tip, which may be located at the bottom end of the shaft 105. The helical portion 140 preferably terminates at the tip.

FIG. 1 also shows that the body 120 may comprise a base 170. The base 170 is preferably the bottom portion of the body 120 and is preferably configured to engage in a ringed manner the top portion of the bottle to be de-corked. In a preferred embodiment, the base 170 is preferably cylindrical ring shape and preferably provides hand support for the user when rotating the shaft 125.

Additionally, FIG. 1 shows that the body may comprise a through hole 136 and shoulders 137, 138. The through hole 136 is preferably configured to allow the shaft 105 to engage with and extrude through the through hole 136. The shoulders 137, 138 are preferably configured to rotatably engage with the levers 110, 115 of the multi-tool corkscrew 100.

FIG. 1 shows that the levers 110, 115 may comprise pins 155, 160, which may be used to movably fasten the levers 110, 115 the body 120 and provide rotational movement for the levers 110, 115 and for the gear teeth 145, 150. The rotational movement of the levers 110, 115 around the pins 155, 160 preferably causes the gear teeth 155, 160 to engage and push in a vertical manner the rack portion 135, such that the shaft 105 moves linearly, thereby causing the shaft 105 to displace vertically up or down relative to the body 120 upon actuation of the levers 110, 115.

When in use, the corkscrew 100 is preferably positioned above the bottle such that the tip of the helical portion 140 of the shaft 105 may contact the cork. The user may then push and rotate the handle portion 125, which may cause the helical portion 140 of the shaft 105 to engage and penetrate into the cork. Thus, as the helical portion 140 engages with a cork in a bottle, the shaft 105 generally shifts downwards. The user then may push down onto the levers 110, 115, so that the shaft 105 moves upwards and draws the helical portion 140 and the cork from the bottle.

FIG. 2 is an illustration of a rear elevational view of one embodiment of the winged corkscrew with one or more secondary utensils. As shown in FIG. 2, one embodiment of the corkscrew 100 may comprise: a shaft 105, levers 110, 115, and body 120. The shaft 105 may comprise: a handle portion 125, rack 135, and helical portion 140. Each lever 110, 115 may comprise gear teeth 145, 150 and pins 155, 160, and the body 120 may comprise a base 170.

FIG. 3 is an illustration of a right side elevational view of one embodiment of the winged corkscrew with one or more secondary utensils. As shown in FIG. 3, one embodiment of the corkscrew 100 may comprise: a shaft 105, lever 115, and body 120. The shaft 105 may comprise: a handle portion 125, secondary utensils 130, 131, and rack 135. Lever 115 may comprise gear teeth 150 and pin 160. The body 120 may comprise the base 170.

FIG. 4 is an illustration of a left side elevational view of one embodiment of the winged corkscrew with one or more secondary utensils. As shown in FIG. 4, one embodiment of the corkscrew 100 may comprise: a shaft 105, lever 110, and body 120. The shaft 105 may comprise: a handle portion 125, secondary utensils 130, 131, and rack 135. Lever 115 may comprise gear teeth 145 and pin 155. The body 120 may comprise the base 170.

FIG. 5 is an illustration of a top plan view of one embodiment of the winged corkscrew with one or more secondary utensils. As shown in FIG. 5, one embodiment of the corkscrew 100 may comprise: a handle portion 125, secondary utensil 130, and base 170.

FIG. 6 is an illustration of a bottom plan view of one embodiment of the winged corkscrew with one or more secondary utensils. As shown in FIG. 6, one embodiment of the corkscrew 100 may comprise: levers 110, 115, body 120, and helical portion 140.

FIG. 7 is an illustration of a perspective view of one embodiment of the winged corkscrew with one or more secondary utensils. As shown in FIG. 7, one embodiment of the utensil corkscrew 100 may comprise: a shaft 105, levers 110, 115, and body 120. The shaft 105 may comprise: a handle portion 125, secondary utensils 130, 131, rack 135, and helical portion 140. FIG. 7 also shows that each lever 110, 115 may comprise gear teeth 155, 160 and pins 155, 160, which may be used to movably fasten and secure the levers 110, 115 to the body 120. The body 120 may comprise a base 170.

FIG. 8 is an illustration of a perspective view of one embodiment of the winged corkscrew with one or more secondary utensils and shows two secondary utensils hingedly protracted. As shown in FIG. 8, one embodiment of the corkscrew 800 may comprise: a shaft 105, levers 110, 115, and body 120. The shaft 105 may comprise: a handle portion 125, secondary utensils 804, rack 135, and helical portion 140. FIG. 1 also shows that each lever 110, 115 may comprise gear teeth 155, 160 and pins 155, 160, which may be used to movably fasten and secure the levers 110, 115 to the body 120. The body 120 may comprise a base 170. FIG. 8 shows the secondary utensil 130 protracted and that the secondary utensils 804 may comprise two secondary utensils—a prick 801 and a blade 802, which may be referred to as a cutting tool or knife. FIG. 8 also shows that the opening 175 of the handle portion 125 may comprise a lip 180, which is configured to function as a bottle cap opener or bottle opener.

FIG. 9 is an illustration of another embodiment of the handle portion of the corkscrew with one or more secondary utensils and shows the secondary utensils as a can opener with a double-point prick. Specifically, FIG. 9 shows that the cork screw 900 may comprise two secondary utensils 904—a double prick 901 and a can opener 902. The can opener 902 may also comprise a notch 903 to assist the user in protracting the secondary utensils 901, 902. FIG. 9 also shows that the opening 975 of the handle portion 925 may comprise a lip 980, which is configured to function as a bottle cap opener. The handle portion 925 may be various shapes, including being substantially rectangular in shape, as shown.

FIG. 10 is an illustration of another embodiment of the handle portion of the corkscrew with one or more secondary utensils and shows the secondary utensils as a cutting tool and a serrated blade. Specifically, FIG. 10 shows that the corkscrew 1000 may comprise two secondary utensils 1004—a serrated blade 1001 and a blade 1002. The blade 1003 may also comprise a notch 1003 to assist the user in protracting the secondary utensils 1001, 1002. FIG. 10 also shows that the opening 1075 of the handle portion 1025 may comprise a lip 1080, which may be configured to function as a bottle cap opener. FIG. 10 also shows that the handle portion 1025 may be substantially trapezoidal in shape.

FIG. 11 is an illustration of another embodiment of the handle portion of the corkscrew with one or more secondary utensils and shows the secondary utensils as scissors and a single-point prick. Specifically, FIG. 11 shows that the secondary utensils 1104 of the corkscrew 1100 may comprise two secondary utensils 1104—a single-point prick 1101 and a scissors 1102. FIG. 11 also shows that the opening 1175 of the handle portion 1125 may comprise a lip 1180, configured as a bottle cap opener. FIG. 11 also shows that the handle portion 1125 may be substantially circular in shape. A lip 1180 may be positioned within the inner edge of the opening 1175 of the handle portion 1125. In this embodiment, the scissors 1102 may be used for cutting the foil wrapper, plastic wrapping, and/or outside packaging of the bottle (e.g., box packaging, plastic shrink-wrap). The scissors, for example, may be used for cutting the bow and string of the bottle when the bottle is gift-wrapped.

FIG. 12 is an illustration of a perspective view of one embodiment of the winged corkscrew and shows the corkscrew with a single secondary utensil. FIG. 12 shows that corkscrew 1200 may comprise a single secondary utensil 1204, which is shown as a curved foil cutting blade 1202.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A winged corkscrew with one or more secondary utensils, comprising:
a shaft;
a body; and
two levers;
wherein each of said two levers comprise a pin, such that there are two pins;
wherein said shaft comprises: a handle portion, one or more secondary utensils, a rack portion, and a helical portion;
wherein said handle portion is positioned at an upper end of said shaft;
wherein said one or more secondary utensils are hingedly disposed between said handle portion and said rack portion;
wherein said rack portion is disposed between said one or more secondary utensils and said helical portion;
wherein said helical portion is positioned at a bottom end of said shaft and is configured to engage with and remove a cork from a bottle;
wherein said body comprises a through hole, two shoulders, and a base;
wherein said through hole is positioned approximately at said upper end of said body, between said two shoulders, and above said base;
wherein said shaft engages with and extends through said through hole of said body;
wherein a proximal ends of said two levers comprises a plurality of gear teeth;
wherein said proximal ends of said one or more levers pivotally rotates with said one or more shoulders of said body via said two pins, such that said plurality of gear teeth of said two levers moveably rotate adjacent to said through hole;
wherein said rack portion of said shaft engages with said plurality of gear teeth of said two levers; and
wherein said base of said body is substantially cylindrical and is adapted to engage with a neck portion of a bottle.

2. The combination tool of claim 1, wherein said one or more secondary utensils are aligned in a substantially horizontal manner, such that a length of said one or more secondary utensils transverses longitudinally along a bottom portion of said handle portion, such that said one or more secondary utensils are substantially perpendicular to said shaft.

3. The combination tool of claim 1, wherein said handle portion of said shaft comprises at least one opening and at least one lip;
wherein said at least one lip is disposed along an inner edge of said at least one opening; and
wherein said at least one lip is adapted to engage with a sealing cap of a bottle, such that said handle portion functions as a bottle cap opener.

4. The combination tool of claim 1, wherein a shape of said handle portion of said shaft is selected from the group of shapes consisting of: a rectangular shape, a trapezoidal shape, and a circular shape.

5. The combination tool of claim 1, wherein said one or more secondary utensils are aligned along a lower portion said handle portion, such that said winged corkscrew is configured to align with a top portion of a bottle.

6. The combination tool of claim 1, wherein said one or more secondary utensils are aligned along a lower portion said handle portion to provide compactness of said one or more secondary utensils.

7. The combination tool of claim 1, wherein said one or more secondary utensils includes a blade.

8. The combination tool of claim 7, wherein said one or more secondary utensils includes a double-point prick.

9. The combination tool of claim 7, wherein said one or more secondary utensils includes a serrated blade.

10. The combination tool of claim 7, wherein said one or more secondary utensils includes a screwdriver tip.

11. The combination tool of claim 1, wherein said one or more secondary utensils are selected from the group of secondary utensils consisting of: a cap lifter, a single-point prick, and a scissor tip.

12. A winged corkscrew with one or more secondary utensils, comprising:
a shaft;
a body; and
two levers;
wherein each of said two levers comprise a pin, such that there are two pins;
wherein said shaft comprises: a handle portion, at least one secondary utensil, a rack portion, and a helical portion;
wherein said handle portion is positioned at an upper end of said shaft and comprises at least one opening;
wherein said at least one secondary utensil is hingedly disposed between said handle portion and said rack portion;
wherein said rack portion is disposed between said at least one secondary utensil and said helical portion;
wherein said helical portion is positioned at a bottom end of said shaft and is configured to engage with and remove a cork from a bottle;
wherein a proximal ends of said two levers comprise a plurality of gear teeth;
wherein said body comprises: a through hole, two shoulders, and a base;
wherein said through hole is positioned approximately at an upper end of said body, between said two shoulders, and above said base;
wherein said proximal ends of said two levers pivotally rotates with said two shoulders of said body via said two pins, such that said plurality of gear teeth of said two levers moveably rotate adjacent to said through hole;
wherein said shaft engages and extends through said through hole of said body, such that said helical portion of said shaft is disposed within said body and said rack portion of said shaft engages with said plurality of gear teeth of two levers; and
wherein said base of said body is substantially cylindrical and is adapted to engage with a neck portion of a bottle.

13. The combination tool of claim 12, wherein said at least one secondary utensil is aligned in a substantially horizontal manner, such that a length of said at least one secondary utensil transverses longitudinally along a bottom portion of said handle portion, such that said one or more secondary utensils are substantially perpendicular to said shaft.

14. The combination tool of claim 12, wherein said handle portion of said shaft comprises at least one opening and at least one lip;
wherein said at least one lip is disposed along an inner edge of said at least one opening; and
wherein said at least one lip is adapted to engage with a sealing cap of a bottle, such that said handle portion functions as a bottle cap opener.

15. The combination tool of claim 12, wherein a shape of said handle portion of said shaft is selected from the group of shapes consisting of: a rectangular shape, a trapezoidal shape, and a circular shape.

16. The combination tool of claim 12, wherein said one or more secondary utensils are aligned along a lower portion said handle portion, such that said winged corkscrew is configured to align with a top portion of a bottle.

17. The combination tool of claim 12, wherein said one or more secondary utensils are aligned along a lower portion said handle portion to provide compactness of said one or more secondary utensils.

18. The combination tool of claim 12, wherein said at least one secondary utensil is a blade.

19. The combination tool of claim 12, wherein said at least one secondary utensil is selected from the group of secondary utensils consisting of: a blade, a serrated blade, a cap lifter, a single-point prick, a double-point prick, a scissor tip, and a screwdriver tip.

20. A winged corkscrew with one or more secondary utensils, consisting essentially of:
a shaft;
a body;
a first lever, comprising a first pin; and
a second lever, comprising a second pin;
wherein said shaft consists essentially of: a handle portion, two secondary utensils, a rack portion, and a helical portion;
wherein said handle portion is positioned at an upper end of said shaft and comprises at least one opening and at least one lip;
wherein said at least one lip is disposed along an inner edge of said at least one opening and is adapted to engage with a sealing cap of a bottle, such that said shaft functions as a bottle cap opener;
wherein said two secondary utensils are hingedly disposed between said handle portion and said rack portion and is aligned in a substantial horizontal manner, such that a length of said two secondary utensils transverse longitudinally along a bottom portion of said handle portion;
wherein said rack portion is disposed between said two secondary utensils and said helical portion;
wherein said helical portion is positioned at a bottom end of said shaft and is configured to engage with a cork;
wherein a proximal end of said first lever comprises a plurality of gear teeth;
wherein a proximal end of said second lever comprises a plurality of gear teeth;
wherein said body comprises: a through hole, a first shoulder, a second shoulder, and a base;
wherein said through hole is positioned at an upper end of said body, adjacent to and between said first shoulder and said second shoulder, and above said base;
wherein said proximal end of said first lever pivotally engages with said first shoulder of said main body via said first pin, such that said plurality of gear teeth of said first lever moveably rotates adjacent to said through hole;
wherein said proximal end of said second lever pivotally engages with said second shoulder of said main body via said second pin, such that said plurality of gear teeth of said second lever also moveably rotates adjacent to said through hole;
wherein said shaft engages and extends through said through hole of said body, such that said helical portion of said shaft is disposed within said body and said rack portion of said shaft engages with said plurality of gear teeth of said first lever and said plurality of gear teeth of said second lever; and
wherein said base of said body is substantially cylindrical and is adapted to engage with a neck portion of said bottle.
